(19) United States
(12) Patent Application Publication
(10) Pub. No.: US 2024/0367664 A1
(43) Pub. Date: Nov. 7, 2024

(54) A METHOD FOR OPERATING AN ASSISTANCE SYSTEM OF AN AT LEAST IN PART AUTOMATICALLY OPERATED MOTOR VEHICLE AS WELL AS AN ASSISTANCE SYSTEM

(71) Applicant: VALEO SCHALTER UND SENSOREN GMBH, Bietigheim-Bissingen (DE)

(72) Inventors: Fernando Garrido Carpio, Bobigny (FR); Paulo Lopes Resende, Bobigny (FR)

(73) Assignee: VALEO SCHALTER UND SENSOREN GMBH, Bietigheim-Bissingen (DE)

(21) Appl. No.: 18/688,198

(22) PCT Filed: Aug. 31, 2022
(86) PCT No.: PCT/EP2022/074238

§ 371 Date: Feb. 29, 2024

(30) Foreign Application Priority Data
Sep. 6, 2021 (DE) 10 2021 122 950.2

(51) Int. Cl. B60W 50/023; B60W 50/035

(52) U.S. Cl. CPC B60W 50/023; B60W 50/035

(57) ABSTRACT

A method for operating an assistance system of an at least in part automatically operated motor vehicle is disclosed. The method includes capturing an environment of the motor vehicle by at least one capturing device, evaluating a first driving strategy, evaluating a second driving strategy, comparing the first driving strategy and the second driving strategy, and depending on a result of the comparison of the two driving strategies, generating a fallback driving strategy. The fallback strategy is different from the first driving strategy and the second driving strategy. The first driving strategy is evaluated by a first electronic computing device of the assistance system using a first evaluation algorithm. The second driving strategy is evaluated by a second electronic computing device of the assistance system using a second evaluation algorithm which is different from the first evaluation algorithm.

The invention relates to a method for operating an assistance system of an at least in part automatically operated motor vehicle. Furthermore, the invention relates to a computer program product, a computer-readable storage medium as well as an assistance system.

Supervision stage is one of the stages of an architecture of at least in part automatically operated motor vehicles, in particular of a fully automated motor vehicle. Its main goal is to check the correct behavior of the assistance system. The different systems that compose this stage have to warn a user of the motor vehicle/driver of the motor vehicle and apply corrective actions in order to bring the motor vehicle back to a safe state. These corrective actions are commands from an electronic computing device related to planning, for example trajectory planning or maneuver planning, or to control the vehicle, such as acceleration or steering. Some examples of supervision systems are the emergency braking or the minimum risk maneuver.

One of the main challenges of this supervision stage is that currently, there is no standardized way of comparing commands of two electronic computing devices, evaluating if they are good or not, or which one is better to be executed by the at least in part automatically operated motor vehicle. For example, there is no standardized way of deciding if a trajectory is good or not, and there is no objective way to compare two trajectories. Therefore, it is difficult for the supervision stage to decide if the trajectory planned is good enough or not or to decide if a fallback function, in this particular case a trajectory, should be followed instead of the planned one, and how to deal with the transitions (in this case from a trajectory to the fallback one).

In the state of the art, the existing solutions directly execute a fallback function, such as an emergency braking or a minimum risk maneuver, from the original planned one, without comparing and evaluating different alternatives, which could avoid passing to the fallback functions. These alternatives will be less aggressive since they are not fallback functions. Additionally, the transition of the fallback function may be less abrupt by anticipating the need of passing through the current function to the fallback function.

WO 2018/069 061 A1 relates to a method for formulating a piloting setpoint for a driving member of an automotive vehicle, comprising the steps of: computing three preliminary piloting setpoints for said driving member, having regard to signals emitted by sensors, comparing the first and the second preliminary piloting setpoints, and deducing a first opinion as regards the presence of a computation error, determining the presence of the absence of an obstacle around the automotive vehicle, and deducing a second opinion as regards the presence of a computation error, and collating the first and second opinion, and piloting of that driving member by a main computer or by an auxiliary computer as a function of the result of the collating.

WO 2019/025 333 A1 relates to a method for creating a supervision setpoint for controlling a driving member of a motor vehicle provided with a plurality of sensors, comprising: a first step of merging the signals received from at least one first portion of the sensors, to determine at least one first data item relating to the environment around the motor vehicle, a second step of merging the signals received from at least one second portion of the sensors, to determine at least one second data item relating to the environment around the motor vehicle, a step of calculating a first preliminary supervision setpoint according to each first data item, a step of comparing the first and second data items to establish a first diagnosis, a step of controlling the first preliminary supervision setpoint, taking into account at least one of the first and second data items, to establish a second diagnosis, and a step of determining the supervision setpoint according to the first and second diagnosis.

It is an object of the invention to provide a method, a computer program, a computer-readable storage medium as well as an assistance system, by which a higher safety is provided in the road traffic.

This object is solved by a method, a computer program product, a computer-readable storage medium as well as an assistance system according to the independent claims. Advantageous forms of configuration are presented in the dependent claims.

One aspect of the invention relates to a method for operating an assistance system of an at least in part automatically operated motor vehicle. An environment of the motor vehicle is captured by at least one capturing device of the assistance system. A first driving strategy is evaluated by a first electronic computing device of the assistance system using a first evaluation algorithm. An evaluating of a second driving strategy by a second electronic computing device of the assistance system using a second evaluation algorithm, which is different from the first evaluation algorithm, is performed. The first driving strategy and the second driving strategy are compared by the assistance system. Depending on the result of the comparison of the two driving strategies, a fallback driving strategy by a third electronic computing device of the assistance system is generated, wherein the fallback strategy is different from the first driving strategy and the second driving strategy.

Therefore, a safer way for driving the at least in part automatically operated motor vehicle in the road traffic is performed by using the method. In particular, if the comparison fails between the first driving strategy and the second driving strategy, or if the comparison succeeds but at least the evaluation of one of the strategies fails, then the fallback driving strategy, which may be, for example, an emergency maneuver or a minimum risk maneuver, is performed by the assistance system.

In particular, the motor vehicle may be an at least in part automatically operated motor vehicle, wherein the at least in part automatically operated motor vehicle may comprise means for performing lateral and longitudinal accelerations. For example, according to a driving strategy, the assistance system may accelerate or brake the motor vehicle or may change the direction of the motor vehicle. In particular, the at least in part automatically operated motor vehicle may be a fully automated motor vehicle.

Therefore, a comparison and evaluation of different driving strategies from the two different electronic computing devices is performed, wherein the choice of the actuator commands and/or planning related commands, for example routes, trajectories or maneuvers, and verifying the need of a transition to the fallback function is performed. In the case that a transition is needed, a transition strategy may be defined to avoid directly executing the fallback function.

In order to decide if a driving strategy, such as a trajectory, is good enough for the motor vehicle to be tracked or not, it has to be evaluated. This evaluation has to be objective. Thus, it must be done based on evaluation matrix, such as a curvature, speed limit, lateral acceleration or furthermore. The function is then evaluated checking if the metric values are in the range considered as valid. For instance, a trajectory is not valid if the curvature in any of its points is higher than the maximum curvature feasible for the automated vehicle.

Therefore, in the case that the current command is good enough, at least the motor vehicle is able to follow this command before a transition to a fallback function is performed or just follow this command if both current and alternative commands are good enough.

In order to know if a further transition to a fallback function is needed, a comparison phase is needed. There, the current command, in particular the first driving strategy, is compared with the second driving strategy, generated with a different algorithm. For example, the first driving strategy represents a trajectory planned by an end-to-end approach, whereas the second driving strategy would represent a trajectory generated by a classical motion planning approach. Both commands are compared not only in the space state, but also in a time state. It means that two commands are considered equivalent if both the distance and the speed states of both commands are the same or with a slight difference between them. In any other case, a transition phase to the fallback function is needed, and that way, the assistance system is anticipating the system response, making the change less abrupt, and in the worst case, if both driving strategies are not valid since the evaluation fails for both strategies, this fallback function is executed directly, being the worst case scenario.

As an example, there may be the first driving strategy, which decides that keeping a lane maneuver is the correct driving strategy, generated by the first electronic computing device. The second electronic computing device, which may be an alternative function, may decide a change-lane-right maneuver is the correct maneuver. The third electronic computing device generates a minimum risk maneuver as the fallback function.

The evaluation of the first driving strategy is “okay” when the keep-lane maneuver respects the criteria and the metrics are in the range of valid metrics. For example, this maneuver could be valid if it is a feasible maneuver with respect to the traffic rules and road conditions. This first driving strategy may be not valid, for example, if there is a risk of a collision with another motor vehicle, which has the priority. Meanwhile, the evaluation result of the second driving strategy is that the maneuver is valid since the motor vehicle may, for example, be able to turn right without any collision risk.

For the preceding maneuvers of the first driving strategy and the second driving strategy, the comparison would be “fail” since the values are not the same, for example one maneuver is “keep line” and the other is “change lane right”. If the driving strategies are compared as trajectories, the comparison would be “okay” if the difference between the passed points is lower than the limit set as normal, for example it could be the perception error. In case of comparing longitudinal control electronic computing devices, the comparison would be done with a difference of speed of acceleration, whereas in the case of lateral control, the comparison would be done through the difference of a steering angle or equivalent.

According to an embodiment, the fallback strategy is an emergency maneuver. The fallback strategy may be a minimum risk maneuver, wherein, for example, a stop of the at least in part automatically operated motor vehicle without the risk of a collision may be performed. Therefore, the fallback strategy used if the comparison between the first driving strategy and the second driving strategy fails or if the evaluation of at least one of the two strategies fails. Therefore, a safer way of driving the at least in part automatically operated motor vehicle in the road traffic is performed.

In another advantageous form, the first electronic computing device is a main electronic computing device for maneuver planning and the second electronic computing device is an alternative electronic computing device for maneuver planning. For example, the first electronic computing device may be a rule-based maneuver planner, and the second electronic computing device may be a learning-based maneuver planner. Usually, the at least in part automatically operated motor vehicle may use the commands of the first electronic computing device.

According to another embodiment, if the first driving strategy is valid and the second driving strategy is not valid, a transition strategy from the first driving strategy to the fallback strategy is devised by the assistance system, and/or if the second driving strategy is valid and the first driving strategy is not valid, a transition strategy from the second driving strategy to the fallback strategy is devised by the assistance system. Therefore, a less abrupt maneuver in the road traffic is performed by the assistance system. The transition strategy to the fallback function allows to anticipate the response preparing the system, making this response less abrupt, allowing to select either the main function, in particular the first driving strategy, or the second driving strategy before transitioning is performed, if needed, to the fallback function. Therefore, only two cases for a direct transition to the fallback function are provided. It means that in any other case, the system is anticipating response to the fallback function, allowing the system to have a less abrupt and risky response, for example in terms of lateral and longitudinal acceleration. In the case a transition is needed, the transition strategy is defined to avoid directly executing the fallback function.

According to another embodiment, the transition strategy initially performs the first driving strategy and then transitions to performing the fallback strategy or the transition strategy initially performs the second driving strategy and then transitions to performing the fallback strategy. For example, if the second driving strategy is not valid, then the first driving strategy is initially performed and then transitions to the fallback strategy. If the first driving strategy is not valid, then the second driving strategy and then the transition to the fallback strategy is performed. Therefore, a safer way for driving the at least in part automatically operated motor vehicle in the road traffic is realized.

According to another advantageous form of configuration, during performing the transition strategy, a new evaluation of the first driving strategy and the second strategy and a new comparison are performed by the assistance system, and depending on the result of the new comparison, a new decision for performing the new first driving strategy or the new second driving strategy or a new transition strategy or a new fallback strategy is made by the assistance system. For example, if the transition strategy is performed by the assistance system, then a new evaluation may be performed and, for example, in the new evaluation, the new first driving strategy and the new second driving strategy may be valid and the comparison may also be “okay”. Then, the assistance system may decide not to switch to the fallback function, but to switch to the new first driving strategy, as there is no risk for performing the new first driving strategy. Therefore, a time buffer may be presented, wherein a new decision can be made and therefore, for example, the fallback function may be omitted.

Furthermore, it has turned out to be advantageous if the first driving strategy is not valid and the second driving strategy is not valid, the fallback strategy is immediately performed by the assistance system. Because no driving strategy is valid, the system has to perform the fallback strategy, for example an emergency brake or a minimum risk maneuver, in order to avoid, for example, a collision.

In another embodiment, if the first driving strategy is valid and the second driving strategy is valid, the first driving strategy is performed by the assistance system, whereas the second driving strategy and the fallback strategy are omitted by the assistance system. In particular, if the first electronic computing device may be the main electronic computing device, then the first driving strategy is performed by the electronic computing device.

In another advantageous form of configuration, the first driving strategy and the second driving strategy are compared by comparing each trajectory, including each geometric path and/or each velocity. In particular, the comparison is done by the geometric path and the velocity profile. If they are similar or equivalent, the comparison does not fail and the fallback function has not to be performed by the assistance system.

Furthermore, it has turned out to be advantageous, when the first driving strategy and the second driving strategy are considered to be equivalent, when the strategies are equivalent within a predetermined threshold. In particular, because the first driving strategy is generated by using a first algorithm and the second driving strategy is generated by using a second algorithm, the results of these algorithms may be at least in part different. In order to present a robust assistance system, the first driving strategy and the second driving strategy just have to be equivalent within a predetermined threshold, wherein a robust assistance system is presented.

In another advantageous form, if the comparison fails, the fallback strategy is performed by the assistance system. Therefore, a minimum risk maneuver or, for example, an emergency maneuver may be performed by the assistance system, wherein the risk of a collision is minimized.

In another embodiment, the first electronic computing device uses a rule-based algorithm for evaluating the first driving strategy and/or the second electronic computing device uses a learning-based algorithm for evaluating the second driving strategy. Therefore, the rule-based machine-learning algorithm typically comprises a set of rules that collectively make up the prediction model. On the other hand, the learning-based method combines a discovery component with a learning component.

In particular, the presented method is a computer-implemented method. Therefore, a further aspect of the invention relates to a computer program product with program code means, which, when the program code means are executed on an electronic computing device, cause it to perform a method according to the preceding aspect.

A still further aspect of the invention relates to a computer-readable storage medium with a computer program product according to the preceding aspect.

Another aspect of the invention relates to an assistance system for an at least in part automatically operated motor vehicle, the assistance system comprising at least one capturing device, at least one first electronic computing device, one second electronic computing device and one third electronic computing device, wherein the assistance system is configured for performing a method according to the preceding aspect. In particular, the method is performed by the assistance system.

The first electronic computing device, the second electronic computing device and/or the third electronic computing device may comprise means for performing the method. For example, the electronic computing devices may comprise processors, circuits, for example integrated circuits, or other electronics means, for performing the method.

A still further aspect of the invention relates to a motor vehicle comprising the assistance system. In particular, the motor vehicle may be at least in part automatically operated or fully automatically operated.

Advantageous forms of configuration of the method are to be regarded as advantageous forms of configuration of the computer program product, of the computer-readable storage medium, of the assistance system as well as of the motor vehicle. Thereto, the assistance system as well as the motor vehicle comprise concrete features, which allow performing the method or an advantageous form of configuration thereof.

Further features are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim. Moreover, implementations and feature combinations are to be considered as disclosed, in particular by the implementations set out above, which extend beyond or deviate from the feature combinations set out in the relations of the claims.

Now, the invention is explained in more detail based on preferred embodiments as well as with reference to the attached drawings.

There show:

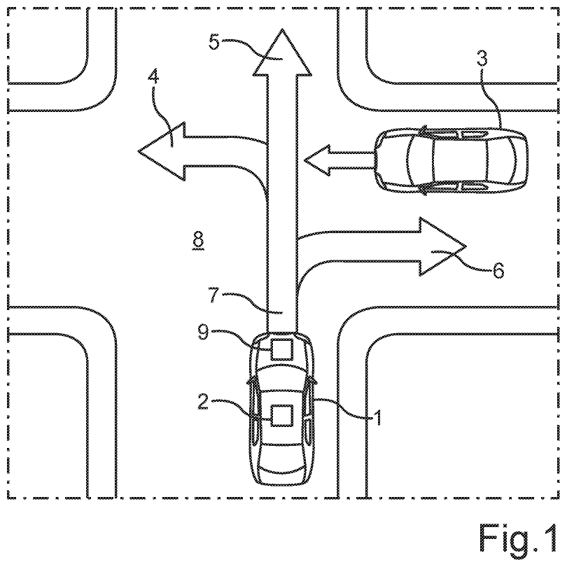

FIG. 1 shows a schematic top view according to an embodiment of a motor vehicle comprising an embodiment of an assistance system in a road traffic situation;

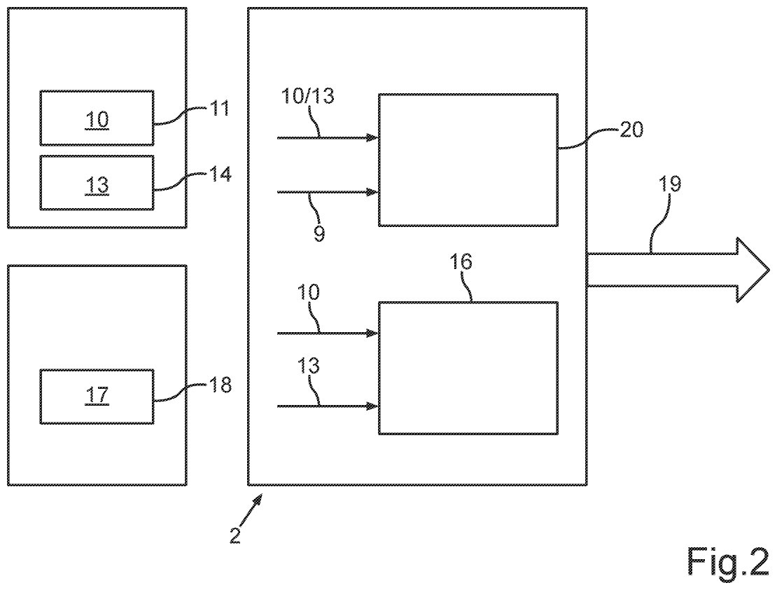

FIG. 2 shows a schematic block diagram according to an embodiment of the assistance system; and

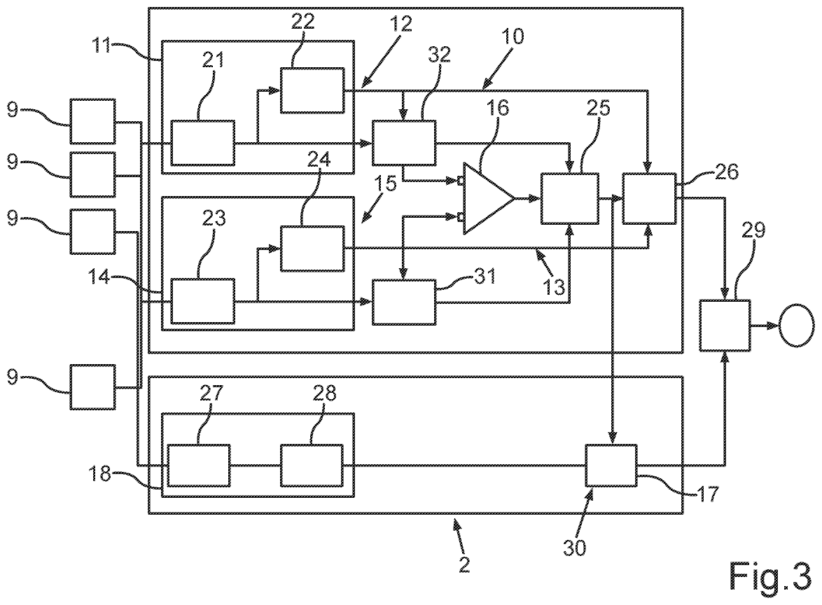

FIG. 3 shows another schematic block diagram according to an embodiment of the assistance system.

In the figures, the elements having the same function are indicated by the same reference signs.

FIG. 1 shows in a schematic top view according to an embodiment of a motor vehicle 1 comprising an assistance system 2 in a road traffic situation. A second motor vehicle 3 is shown, wherein the motor vehicle 1 and the second motor vehicle 3 are driving to an intersection. The second motor vehicle 3 has priority because the second motor vehicle 3 is on the right side of the motor vehicle 1. The motor vehicle 1 is at least in part automatically operated, maybe fully automatically operated.

Furthermore, there are four possible maneuvers shown. A first maneuver 4 may be, for example, a turn left, a second maneuver 5 may be, for example, keep lane for crossing the intersection straight ahead; a third maneuver 6 may be a right turn, and a fourth maneuver 7 may be a braking, for example an emergency braking.

In one embodiment of the invention, a method for operating the assistance system 2 of the at least in part automatically operated motor vehicle 1 is presented. An environment 8 of the motor vehicle 1 is captured by at least one capturing device 9 of the motor vehicle 1. A first driving strategy 10 (FIG. 2) is evaluated by a first electronic computing device 11 (FIG. 2) of the assistance system 2 using a first algorithm 12 (FIG. 3). A second driving strategy 13 (FIG. 2) is evaluated by a second electronic computing device 14 (FIG. 2) of the assistance system 2 using a second evaluation algorithm 15 (FIG. 3), which is different from the first evaluation algorithm 12. The first driving strategy 10 and the second driving strategy 13 are compared by the assistance system, which is shown with a block 16 (FIG. 2). Depending on the result of the comparison of the two driving strategies 10, 13, and on the result of the evaluation of the two driving strategies performed by the block 20 (FIG. 2), a fallback driving strategy 17 (FIG. 2) is generated by a third electronic computing device 18 (FIG. 2) of the assistance system 2, wherein the fallback strategy 17 is different from the first driving strategy 10 and the second driving strategy 13.

In particular, the fallback strategy 17 may be an emergency maneuver or a minimum risk maneuver, which may be, for example, the fourth maneuver 7 (FIG. 1).

In particular, if the first driving strategy 10 is valid and the second driving strategy 13 is not valid, a transition strategy 19 (FIG. 2) from the first driving strategy 10 to the fallback strategy 17 is devised by the assistance system 2 and/or, if the second driving strategy 13 is valid and the first driving strategy 10 is not valid, a transition strategy 19 from the second driving strategy 13 to the fallback strategy 17 is devised by the assistance system. The transition strategy 19 initially performs the first driving strategy 10 and then transitions to performing the fallback strategy 17 or the transition strategy 19 initially performs the second driving strategy 13 and then transitions to performing the fallback strategy 13.

During performing the transition strategy 19, a new evaluation of the first driving strategy 10 and the second driving strategy 13 and a new comparison are performed by the assistance system 2, and depending on the result of the new evaluations and comparison, a new decision for performing the new first driving strategy 10 or the new second driving strategy 13 or a new transition strategy 19 or a new fallback strategy 17 is made by the assistance system 2.

In order to decide if a driving strategy 10, 13, such as a trajectory, is good enough for the motor vehicle 1 to be tracked or not, this has to be evaluated, which is shown by a block 20 in FIG. 2. This evaluation has to be objective. Thus, it must be done based on evaluation metrics, such as a curvature, speed limit, lateral acceleration or furthermore. The function is therefore evaluated checking if the metric values are in the range considered as valid. For instance, a trajectory is not valid if the curvature in any of its points is higher than the maximum curvature feasible for the automated vehicle.

Therefore, in case the current command/driving strategy 10, 13 is good enough, at least the motor vehicle 1 may follow it before a transition through the fallback function 17 is performed or just follows the commands if both current and alternative commands are good enough.

In order to know if a transition to the fallback strategy 17 is needed, a comparison phase is needed. Therefore, the first driving strategy 10 is compared with the second driving strategy 13, generated with a different algorithm. For example, the first driving strategy 10 represents a trajectory planned by an end-to-end approach, whereas the second driving strategy 13 represents a trajectory generated by a classical motion planning approach. Both commands/driving strategies 10, 13 are compared not only in a space state, but also in the time state. It means that two commands are considered equivalent if both the geometric path and the speed profile of both driving strategies 10, 13 are the same or within a slight difference between them. In any other case, a transition phase to the fallback strategy 17 is needed, and that way, the assistance system 2 responds, making the change less abrupt.

As an example, the first driving strategy may be a keep lane maneuver, which is the second maneuver 5 and may be generated by the first electronic computing device 11. The first electronic computing device 11 may be, for example, a rule-based maneuver planner. The second electronic computing device 14 may decide to make a change right, which is represented by the third maneuver 6, and is generated by the alternative function, for example, which may be a learning-based maneuver planner. The third electronic computing device 18 is a minimum risk maneuver planner and generates the fallback strategy 17.

According to the embodiment shown in FIG. 1, the evaluation of the first driving strategy 10 is “okay” (OK) when the keep-lane maneuver respects the criteria and the metrics are in the range of value metrics. For example, this maneuver could be valid if it is a feasible maneuver with respect to the traffic rules and road conditions. According to FIG. 1, the intersection scenario is shown. There, the first driving strategy 10 is not valid, since there is a risk of collision with the second motor vehicle 3, which has priority. Meanwhile, the evaluation result of the second driving strategy 13 is that the maneuver is valid, since the motor vehicle 1 can turn right without collision risk.

For the preceding driving strategies 10, 13, the comparison would “not be okay” (NOK) since their values are not the same, for example, one maneuver is “keep lane” and the other is “change lane right”. If the functions of the electronic computing devices 11, 14 to be compared are trajectories, the comparison would be “okay” if the difference between the pass points is lower than the limit as set normal. In case of comparing longitudinal control electronic computing devices 11, 14, the comparison would be done with a difference of speed or acceleration, whereas in the case of lateral control, the comparison would be done through the difference of steering angle or equivalent.

Now a table of the different possibilities for three electronic computing devices 11, 14, 18 is shown. For the person skilled in the art it is obvious that more than three electronic computing device 11, 14, 18 may be used. For example three driving strategies 10, 13, generated by three different algorithms 12, 15 may be used. This is just for example only, and the invention is not restricted by three or four electronic computing devices 11, 14, 18. In the first line of the table the result of the evaluation of the first driving strategy 10 is shown. In the second line of the table the result of the evaluation of the second driving strategy 13 is shown. In the third line the comparison of the two driving strategies 10, 13 are show. And in the last line the result of the assistance system 2 by showing the reference signs of the strategies 10, 13, 17 is presented, wherein the transition strategy is presented by an arrow.

| Eval 10 | OK | NOK | OK | NOK | OK | NOK | OK | NOK |
|---|---|---|---|---|---|---|---|---|
| Eval 13 | OK | OK | NOK | NOK | OK | OK | NOK | NOK |
| Compare | OK | OK | OK | OK | NOK | NOK | NOK | NOK |
| Result | 10 | 13→17 | 10→17 | 17 | 10∥13→17 | 13→17 | 10→17 | 17 |

Once the evaluation and comparison modules have been detailed, different use cases, which are referred to in FIG. 1, are presented.

If the first driving strategy 10 is a “change lane right” maneuver with an eco driving profile, and the second driving strategy 13 is a “change lane right” maneuver with a normal driving profile, both the first driving strategy 10 and the second driving strategy 13 are valid, since they have feasible maneuvers for the motor vehicle 1. The comparison between the first driving strategy 10 and the second driving strategy 13 is “okay” since the resulting maneuver directs the motor vehicle 1 in the same direction, only changing the associated driving style. Therefore, the assistance system 2 executes the first driving strategy 10, which may be the result of the main function, since both main and alternative function result in valid and equivalent driving strategies 10, 13. Then, there is no need of transiting to the fallback strategy 17.

If the first driving strategy 10 is a keep-lane maneuver with normal driving profile, and the second driving strategy 13 is a yield, which means stop and keep lane maneuver, with a normal driving profile, then the first driving strategy is not valid since there is a risk of collision with the second motor vehicle 3. The second driving strategy 13 is valid, since the motor vehicle 1 first stops to yield the second motor vehicle 3 and then keeps lane. The comparison between the first driving strategy 10 and the second driving strategy 13 is “okay” since both maneuvers direct the motor vehicle 1 to the different directions. Therefore, the assistance system 2 has to execute the second driving strategy 13, but eventually the system must execute the fallback strategy 17 since the first driving strategy 10 is not valid.

Equivalent to the prior case, both the first driving strategy 10 and the second driving strategy 13 are in an inverse way, for example, the first driving strategy 10 is the yield and the second driving strategy 13 the keep-lane maneuver. Therefore, the assistance system 2 must execute the first driving strategy 10, but eventually the assistance system 2 must execute the fallback strategy 17 since the first driving strategy 10 of the main function is valid but the second driving strategy 13 of the alternative function is not valid.

If the first driving strategy 10 is a “change lane left” maneuver with a normal driving profile and the second driving strategy 13 is a “change lane left” maneuver with a sporting driving profile, the first driving strategy 10 and the second driving strategy 13 are not valid since there is a risk of collision with the second motor vehicle 3. The comparison between the first driving strategy 10 and the second driving strategy 13 is “okay” since both maneuvers direct the motor vehicle 1 to the same destination. Therefore, the assistance system 2 must execute the fallback strategy 17 immediately, since both the first driving strategy 10 and the second driving strategy 13 are not valid.

If the first driving strategy 10 is a “change lane right” maneuver with a normal driving profile and the second driving strategy 13 is a yield maneuver with a normal driving profile, both the first driving strategy 10 and the second driving strategy 13 are valid since they are feasible maneuvers for the automated motor vehicle 1 with no collision risk. The comparison between the first driving strategy and the second driving strategy 13 is “not okay” since the resulting maneuver direct the motor vehicle 1 to different directions. Therefore, the assistance system 2 must execute either the first driving strategy 10 or even the second driving strategy 13, but eventually, the system must execute the fallback strategy 17 since the first driving strategy 10 and the second driving strategy are valid but not equivalent.

If the first driving strategy 10 is a “change lane left” maneuver with a normal driving profile and the second driving strategy 13 is a yield maneuver with a normal driving profile, the first driving strategy 10 is not valid since there is a risk of collision with the second motor vehicle 3, which has the priority. The second driving strategy 13 is valid since there are feasible maneuvers for the motor vehicle 1 with no collision risk. The comparison between the first driving strategy 10 and the second driving strategy 13 is “not okay” since the resulting maneuver directs the motor vehicle 1 to different directions. Therefore, the system must execute the second driving strategy 13, but eventually, the assistance system 2 must execute the fallback strategy 17, since the first driving strategy 10 of the main function is not valid and additionally, the first driving strategy 10 and the second driving strategy 13 are not equivalent.

According to the prior case, but here, the first driving strategy 10 and the second driving strategy 13 are vice versa, in particular the first driving strategy 10 is a yield maneuver and the second driving strategy is a “change left” maneuver. Therefore, the assistance system 2 must execute the first driving strategy 10, but eventually, the assistance system 2 must execute the fallback strategy 17, since the second driving strategy 13 of the alternative function is not valid and additionally, the first driving strategy 10 and the second driving strategy are not equivalent.

If the first driving strategy 10 is a “change lane left” maneuver with a normal driving profile and the second driving strategy 13 is a “keep lane” maneuver with a normal driving profile, the first driving strategy 10 and the second driving strategy 13 are not valid, since there is a risk of collision with the second motor vehicle 3 which has the priority. The comparison between the first driving strategy 10 and the second driving strategy 13 is “not okay” since the resulting maneuver directs the motor vehicle 1 to two different directions. Therefore, the assistance system 2 must execute the fallback strategy 17 immediately, since both first driving strategy 10 and second driving strategy 13 are not valid.

FIG. 2 shows a schematic block diagram according to the embodiment of the assistance system 2. In particular, FIG. 2 shows the evaluation block 20 as well as the comparison block 16. Furthermore, FIG. 2 shows a block diagram for the decision which driving strategy 10, 13, 17 may be used.

FIG. 3 shows another block diagram according to an embodiment of the assistance system 2. FIG. 3 shows a plurality of capturing devices 9, which may be, for example, a Lidar sensor, a radar sensor, cameras or other sensors. The first electronic computing device 11 generates the first driving strategy 10 and the second electronic computing device 14 generates the second driving strategy 13. The first electronic computing device 11 may comprise a first perception system 21 and a first decision-making system 22. The second electronic computing device 14 may comprise a second perception system 23 and a second decision-making system 24. The first driving strategy 10 and the second driving strategy 13 may be evaluated by an evaluation module. After the first driving strategy 10 and the second driving strategy are evaluated in blocks 32 and 31 respectively, these driving strategies 10, 13 are compared in the comparison block 16. A result block 25 takes both evaluations and the comparison outputs and generates the result of the system to be performed according to the transition table. A first selection block 26 selects the output channel of the first electronic computing device 11 and the second electronic computing device 14 considering the result, which corresponds to the left part of the table, and provides as output the strategy to be executed according to the result.

The third electronic computing device 18 corresponds to the system generating the fallback strategy 17 as described in the table. The result of the fallback function is the fallback strategy 17 which corresponds to the result of the third electronic computing device 18 governing the motor vehicle 3 in the case of the fallback transition as required. The third electronic computing device 18 may also comprise a third perception system 27 and a third decision-making system 28. The second selection module 30 selects the output channel of the third electronic computing device 18 or nothing, considering the result of the result block 25, which corresponds to the right part of the result in the table.

A third selection block 29 is a selector which selects the channel to govern the motor vehicle 1. It considers both the output of the first selection block 26 and a second selection block 30, which decides for the fallback strategy 17. If the output of the second selection block 30 is not empty, this selector now knows that there is a need for transition to the fallback strategy 17, so it governs the motor vehicle 1 with the output from the first selection block 26 waiting enough time to ensure a smooth transition, and then governing the motor vehicle 1 outputting the output of the second selection block 30. In the case of the second selection block 30 output is empty, it means that there is no need of transition to the fallback strategy 17, so the motor vehicle 1 is governed with the output of the first selection block 26 directly.

For a better understanding, now the second case of the Table 1 is presented according to FIG. 1. Therefore, the first driving strategy 10 is a keep-lane maneuver with a normal driving profile, and the second driving strategy 13 is a yield maneuver with a normal profile, and the fallback strategy 17 is a minimum risk maneuver.

In that case, the evaluation of the first driving strategy 10 is “not okay”, the evaluation of the second driving strategy 13 is “okay” and the comparison between the first driving strategy 10 and the second driving strategy 13 is “okay”. Thus, the assistance system 2 passes to govern the motor vehicle 3 with the second driving strategy 13 and wait until it is safe and smooth enough to transit to the fallback strategy 17.

First of all, in the block diagram, the output of the first electronic computing device 11 is the first driving strategy 10 and the output of the second electronic computing device 14 is the second driving strategy 13 and the output of the third electronic computing device 18 is the fallback strategy 17. The output of the first evaluation module 32 is zero, since the evaluation is “not okay” for the first driving strategy 10. The output of the second evaluation module 31 is 1, since the evaluation of the second driving strategy 13 is “okay”. The output of the comparison module 16 is 1, since the comparison of the first driving strategy 10 and the second driving strategy 13 is “okay”, as both maneuvers target the motor vehicle 1 to the same direction. The result of the evaluations and the comparisons is as described in Table 1. This first selection module 26 has to decide between the first driving strategy 10 and the second driving strategy 13, considering the result of the evaluations and comparisons. Thus, the result is the second driving strategy 13 as described in the table and beforehand because the first driving strategy 10 is not valid, wherein the second driving strategy 13 is valid and both are equivalent. The second selection module 30 receives the maneuver of the third electronic computing device 18 and as well as the result from the result module 25. This second selection module 30 only output the fallback strategy 17 in the case that the result is not the first case of the table. It can output the fallback strategy 17 in two ways:

Immediately, for example for the fourth and the last cases of the table. It means that automatically the motor vehicle 1 transfers to the fallback strategy 17.

Eventually, ensuring a safe and smooth transition to the fallback strategy 17. It happens for the second, third, fifth, sixth and seventh case of the Table 1. In those cases, the fallback strategy 17 is transferred eventually to the transition and is ensured to be safe and smooth. Finally, the third selection module 29 receives the maneuver from the first selection module 26, which is the one of the first driving strategy 10 and the second driving strategy 13, and the maneuver from the second selection module 30, which is either the fallback strategy 17 or an empty maneuver.

In the case of an empty maneuver in the second selection module 30, the third selection module 29 will output the maneuver of the first selection module 26, whereas in the case of non-empty maneuver in the second selection module 30, the output is the maneuver of the second selection module 30, in particular the fallback strategy 17.

1. A method for operating an assistance system of an at least in part automatically operated motor vehicle,
the method comprising:
capturing an environment of the motor vehicle by at least one capturing device of the assistance system;
evaluating a first driving strategy by a first electronic computing device of the assistance system using a first evaluation algorithm;
evaluating a second driving strategy by a second electronic computing device of the assistance system using a second evaluation algorithm, which is different to the first evaluation algorithm;
comparing the first driving strategy and the second driving strategy by the assistance system; and
depending on a result of the comparison of the two driving strategies, generating a fallback driving strategy by a third electronic computing device of the assistance system,
wherein the fallback strategy is different from the first driving strategy and the second driving strategy.

2. The method according to claim 1,
wherein the fallback strategy is an emergency maneuver.

3. The method according to claim 1,
wherein the first electronic computing device is a main electronic computing device for maneuver planning and the second electronic computing device is an alternative electronic computing device for maneuver planning.

4. The method according to claim 1,
wherein, if the first driving strategy is valid and the second driving strategy is not valid, a transition strategy from the first driving strategy to the fallback strategy is devised by the assistance system, or
if the second driving strategy is valid and the first driving strategy is not valid, a transition strategy from the second driving strategy to the fallback strategy is devised by the assistance system.

5. The method according to claim 4,
wherein the transition strategy initially performs the first driving strategy and then transitions to performing the fallback strategy, or
the transition strategy initially performs the second driving strategy and then transitions to performing the fallback strategy.

6. The method according to claim 4,
wherein during performing the transition strategy a new evaluation of the first driving strategy and the second driving strategy and a new comparison are performed by the assistance system, and
wherein depending on a result of the new comparison a new decision for performing the new first driving strategy or the new second driving strategy or a new transition strategy or a new fallback strategy is made by the assistance system.

7. The method according to claim 1,
wherein, if the first driving strategy is not valid and the second driving strategy is not valid, the fallback strategy is immediately performed by the assistance system.

8. The method according to claim 1,
wherein, if the first driving strategy is valid and the second driving strategy is valid, the first driving strategy is performed by the assistance system,
wherein the second driving strategy and the fallback strategy is omitted by the assistance system.

9. The method according to claim 1,
wherein the first driving strategy and the second driving strategy are compared by comparing each trajectory and/or each velocity.

10. The method according to claim 9,
wherein the first driving strategy and the second driving strategy are considered to be equivalent, when the strategies are equivalent within a predetermined threshold.

11. The method according to claim 1,
wherein, if the comparison fails, the fallback strategy is performed by the assistance system.

12. The method according to claim 1,
wherein the first electronic computing device uses a rule-based algorithm for evaluating the first driving strategy and/or the second electronic computing device uses a learning-based algorithm for evaluating the second driving strategy.

13. A non-transitory computer readable medium comprising program instructions for causing a processor to perform the method according to claim 1.

14. (canceled)

15. An assistance system for an at least in part automatically operated motor vehicle,
the assistance system comprising at least one capturing device, at least one first electronic computing device, one second electronic computing device and one third electronic computing device,
wherein the assistance system is configured for performing a method according to claim 1.
